(19) United States
(12) Patent Application Publication
(10) Pub. No.: US 2005/0250516 A1
(43) Pub. Date: Nov. 10, 2005

(54) Location information system reflecting user preferences and service providing method thereof

(75) Inventor: Dong-Hee Shim, Seoul (KR)

Correspondence Address: LEE, HONG, DEGERMAN, KANG & SCHMADEKA, 14th Floor, 801 S. Figueroa Street, Los Angeles, CA, 90017, US

(73) Assignee: LG Electronics Inc.

(21) Appl. No.: 11/106,931

(22) Filed: Apr. 14, 2005

Related U.S. Application Data
(60) Provisional application No. 60/561,899, filed on Apr. 14, 2004.
(60) Provisional application No. 60/579,669, filed on Jun. 16, 2004.

(30) Foreign Application Priority Data
Apr. 14, 2004 (KR) 10-2004-025961
May 15, 2004 (KR) 10-2004-034558
Jul. 13, 2004 (KR) 10-2004-054526
Jan. 19, 2005 (KR) 10-2005-005164

(51) Int. Cl. H04Q 7/20

(52) U.S. Cl. 455/456.1; 455/456.6

(57) ABSTRACT

For users with user terminals in a wireless or mobile network, a mechanism is provided for returning a representative location based on the user's profile settings and the user's current physical location. The representative location is not the user's actual physical location, but a conceptual location used for reporting the user's physical location in order to activate various functions and capabilities of the user terminal according to where the user is located. By employing representative locations, various necessary information and corresponding relationships between the user's actual location, which may continuously change due to the user's mobility, and the user preferences containing profile settings allowing the user's terminal to operate in a certain manner designated for certain physical locations, are more efficiently handled and managed.

### CROSS REFERENCE TO RELATED APPLICATIONS

The present application claims the benefit of Korean patent application number 10-2005-005164 filed Jan. 19, 2005, Korean patent application number 10-2004-025961 filed Apr. 14, 2004, Korean patent application number 10-2004-034558 filed May 15, 2004, and Korean patent application number 10-2004-054526 filed Jul. 13, 2004, the disclosures of which are all incorporated herein by reference, and the benefit of U.S. provisional application No. 60/561,899 filed Apr. 14, 2004 and U.S. provisional application No. 60/579,669 filed Jun. 16, 2004, the disclosures of which are incorporated herein by reference.

### BACKGROUND ART

The present invention relates to a mobile (or wireless or radio) communications system, and in particular, to a location information system that allows a user to set different user preferences (user profile settings) according to different regions (locations) and a method of providing a preference information service for such system.

In general, a mobile (or wireless or radio) communications system includes a function unit related to calculating a location of a terminal (e.g., user device, user equipment (UE), mobile handset, etc.) in a mobile communications network, for providing a location service that sends the terminal location information (i.e., the physical location of the user) to a particular entity in a periodic manner or upon request.

The architecture of the network related to the location service differs depending upon the internal network architecture of a 3GPP network, a 3GPP2 network, or other types of networks. There are several methods of calculating the location of the terminal, including a Cell-ID method that sends an identity (ID) of the current cell (region) in which the terminal is located in, a method of measuring the time required for signals to reach each base station (e.g., Node B) from the terminal and then performing triangulation calculations to obtain the location of the terminal, and a method employing global positioning system (GPS) techniques are known.

However, in the related art location information systems, the user can receive his own location information (physical location) but the user cannot respectively set or establish various features according to his location (i.e., physical location upon movement), such as the information being displayed on his terminal, the operation methods of the terminal, and the user preferences (e.g., user profile settings for particular operations of the terminal) for the location report.

### SUMMARY OF THE INVENTION

The present invention employs ‘representative’ locations (e.g., a proxy location, a pseudo location, an abstract location, a symbolic location, etc.), and allows the user to set different user preferences for different locations to provide the user with different terminal operations according to his physical location.

### PURPOSE OF THE INVENTION

The use of ‘representative’ locations and different user preferences for different locations can provide the user with different terminal operations depending upon where the user is physical located.

### BRIEF DESCRIPTION OF THE DRAWINGS

FIG. 1 depicts a schematic diagram of an exemplary location information system according to the present invention.

FIG. 2 depicts a flow chart of a user preference service method for a location information system according to an embodiment of the present invention.

FIG. 3 depicts a location reporting service performed by a SET according to an embodiment of the present invention.

FIG. 4 depicts a location reporting service performed by a SET according to another embodiment of the present invention.

FIG. 5 depicts a location reporting service performed by a SET according to yet another embodiment of the present invention.

FIG. 6 depicts a triggered location reporting service performed by a network according to an embodiment of the present invention.

FIG. 7 depicts a triggered location reporting service performed by a network according to another embodiment of the present invention.

FIG. 8 depicts a standard location reporting service performed by a network according to an embodiment of the present invention.

FIG. 9 depicts a flow chart of a user preference service method for a location information system according to another embodiment of the present invention.

### DETAILED DESCRIPTION

An object of the present invention is to provide a location information system and a preference information service method thereof for allowing the user to set different operations and location reports according to particular regions that the user specifies.

To achieve this object, the location information system and preference information service method according to the present invention has a privacy check entity for setting user preferences according to preference areas, and when a location report request is activated, the preference information that was set for the preference area in which the user is currently located in, is reported as the SET location.

Preferably, the preference information is a proxy location that represents one or more preference areas, and the location report request is activated when a triggered event is performed or when a location report request is actually inputted. Preferably, the triggered event is set by a triggered location report request message. Preferably, the actual location report request is performed by a standard location immediate request message. Preferably, the triggered event includes a report period defined by time periods, a terminal operation defined by ‘UE available’, an area change defined by a ‘change of area’, etc. Preferably, the preference information is reported through a triggered location report response or a standard location immediate answer message. Preferably, if the measured location is not a preference area or if the certain set preference information does not exist, a pre-designated value or the actual location value is reported.

To achieve the above object, the preference information service method of the location information system according to the present invention, comprises: a step of setting preference information according to user preference areas; a step of registering the preference information and each preference area; a step of checking whether the current location of the user is included in a certain preference area; and if the current location of the user is included in the certain preference area, a step of activating the preference information set for the corresponding preference area.

Preferably, the preference information includes information displayed on the terminal, operation methods of the terminal, and a location report method. Preferably, the preference information is stored in a storage media, and each preference area is stored in a separate function unit of a location server. Preferably, the storage media is a privacy check entity, and the function unit receives a user location from the function unit to check whether the user has moved into a particular preference area.

To achieve the above object, the location information system according to the present invention, comprises: a terminal that sets preference information for each particular area; a storage media that stores the set preference information; a location server that registers the preference area having the set preference information and checks whether the user is included in a certain preference area; and an entity that activates the preference information set for the corresponding preference area, if the user is included in the certain preference area

Preferably, the preference area is one of a cell ID, a region with many cell Ids combined together, a city name, and a country name. Preferably, the preference information includes information displayed on the terminal, an operation method of the terminal, and a location report method. Preferably, the preference information is a representative location that represents the actual location of the user. Preferably, the entity is a physical entity that reports the preference information being set for the preference area as a representative location when a location report request is inputted, and the storage media is a privacy check entity. Preferably, the setting of the preference area and of the preference information function are registered in a subscriber profile function unit in the location server, and the subscriber profile function unit, if the preference information function is set therein, receives the location of the user from a location calculation function unit and checks whether the user has moved into a certain preference area.

To achieve the above object, the preference information service method of the location information system according to the present invention, comprises: a step of storing preference information into a terminal application according to user preference areas; a step of receiving location information of the user from a wireless network; and a step, performed in the terminal application, of comparing a current user location information with a preference area and executing the preference information set for the corresponding preference area.

Preferably, the terminal application executes the preference information upon an external request or periodically or when a certain event is triggered. Preferably, the terminal application receives the location information of the user through a location enabler of the terminal. Preferably, the location enabler stores information of a certain preference area having preference information set therefor.

To achieve the above object, the preference information service method of the location information system according to the present invention, comprises: a step of setting a user preference area and preference information for each preference area; a step of measuring an actual location of the user when a location tracking request is generated; and a step of comparing the measured user location with the preference area and reporting the preference information that is set for the corresponding preference area.

Preferably, the preference information is a representative location that represents the actual location of the user, and the representative location includes a name of a particular region, a latitude and longitude information of a particular region, and the like. Preferably, if the measured location is not a preference area or if the certain set preference information does not exist, a pre-designated value or the actual location value is reported. Preferably, the actual location of the user is received from a location server of the network or a location enabler of the terminal.

The preferred exemplary embodiments of the present invention will now be explained. However, those skilled in the art would understand that the features of the present invention should not be limited to only the embodiments described herein.

The present invention provides a location information system that reflects (or considers) user preference information (e.g., user profile settings), provides an interface between each entity of such system, and provides a scheme for activating the user preference information that is set (or designated or established) for a particular region (e.g., physical location) when the user physically moves into (or enters) the corresponding location (or region) that has been previously set.

In the present invention, a location information system reflecting user preference information refers to being able to set different terminal operations and functions for a certain region (physical location) designated by the user. For example, the user of a terminal may set (designate) his ring tone to vibrate mode when at work and to bell sound mode when at home, and also set (designate) his terminal such that international calls cannot be made when at home or such that data service cannot be received. Thus, upon making these settings (designations), the terminal can detect such settings as the user moves about with his terminal such that the terminal is automatically put in vibrate mode when the user enters his workplace or put in ring mode when the user leaves his workplace.

In other words, functions that allow certain preference information (user profiles) that are pre-designated by the user to be activated when that user enters a certain region are part of the location information system according to the present invention. To achieve this, an entity related to allowing activation of particular terminal operations in particular regions must be added, and interfaces related thereto are also additionally needed.

Also, in the present invention, the user preference information (e.g., a user profile) can be stored in a network entity called a user preference repository (e.g., Privacy Check Entity: PCE), and when a request for location tracking of a user is received (i.e., a request to track the current location of the user's terminal), the user's actual physical location value (e.g., x, y, z coordinates, GPS coordinates, etc.) is not reported, but a value that represents the location (or region or area) pre-designated by the user (namely, a representative location, a proxy location, a pseudo location, an abstract location, a symbolic location, a conceptual location, a theoretical location, etc.) that reflects (or considers) the user preference information is employed for reporting.

In other words, the representative location does not indicate the user's actual physical location, but may preferably indicates a larger region or wider area in which the user is physically located.

One advantage of employing the concept of ‘representative locations’ is that the various necessary information and corresponding relationships between the user's actual location (which may continuously change due to the user's mobility) and the user preferences (profile settings allowing the user's terminal to operate in a certain manner) designated for certain physical locations are more efficiently handled and managed.

This reporting of the ‘representative location’ refers to checking the user profile (e.g., the PCE) having user preferences stored therein, comparing the user's actual physical location value with a pre-designated user preference upon receiving a user location tracking request, and reporting a representative location that represents (or signifies or denotes) the user's actual location. The representative location indicates one of the locations within one or more ranges of a ‘preference zone’ that had been designated by the user. For example, the user may designate one of his preference zones to be called ‘home’, which may indicate the city in which he resides in. This ‘home’ zone may have one or more ranges (e.g., smaller regions, boundaries, territories, etc.) designated therein, such as neighborhood names, and each range would have its own representative location that would be used to report the neighborhood name that the user is located in, instead of the user's actual location at a particular street or address within that neighborhood.

Many regions can be set as a representative location, and many representative locations can be set differently for each respective region. Preferably, the regions that are set as a preference zone and the user preference information of each preference zone may be set or modified only by the authorized user himself.

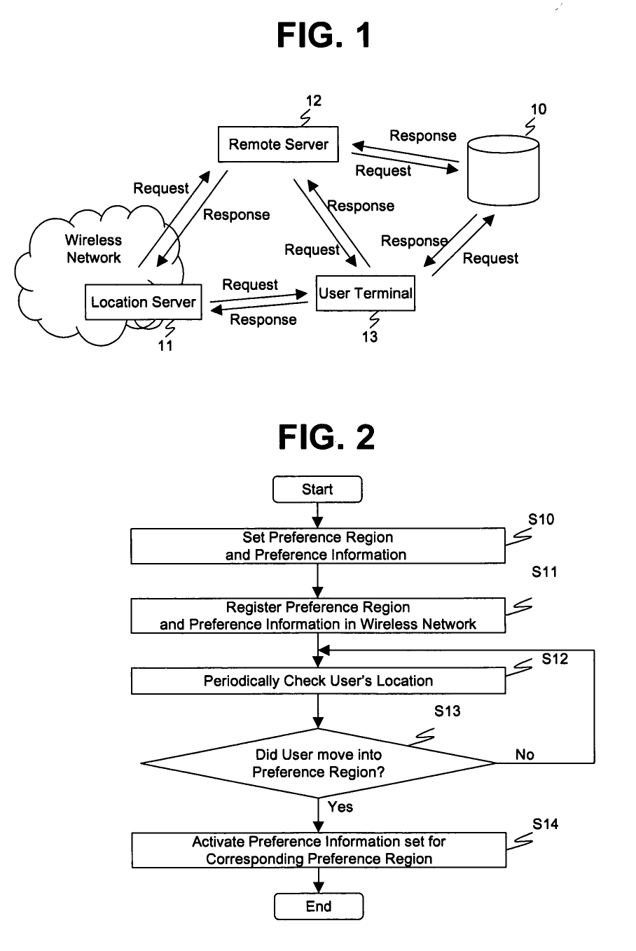

FIG. 1 depicts an exemplary structure of the location information system of an embodiment of the present invention. As shown therein, the location information system can be comprised of a storage media 10, a location server 11, a remote server 12 and a user terminal 13.

The storage media 10 is a network element that exists at one portion of the wireless network, and an example would include a Privacy Check Entity (PCE) or the like. The storage media 10 stores user preference information (user profiles) related to a terminal operation in a particular region, user preference information (e.g., representative locations) that are set for each range of a user preference zone, and the like.

The location server 11 can comprise a subscriber profile function unit, a location calculation function unit that calculates a current location of the terminal (user), and other entities necessary to support the location information service. The subscriber profile function unit can store information regarding whether a service (referred to as a ‘user preference service’ hereafter) related to a terminal operation in a particular region has been set or not (e.g., user preference service is on or off), and information related to the user preference zone that is set by the user. Because the related art entities that handled the location information service did not perform any functions related to user preference information according to the user's location, it can be said that such new particular entities for handling the functions related to the preference information are necessary.

The subscriber profile function unit stores the information related to the preference zone and the information related to whether a preference information service was set or not, and when the user enters a particular location, appropriate procedures are performed to allow activation of the particular terminal operations (e.g., user preferences) that the user had designated. Namely, the subscriber profile function unit reports to the remote server 12 that the user has entered a user preference zone, which was designated by that user, and allows the remote server 12 to activate the preference information pre-designated by the user. Here, the remote server 12 can request and receive the user preference information of the particular region that is stored in the storage media 10.

Also, when there is a user (location) tracking request, the subscriber profile function unit compares the user's actual physical location value provided from the location calculation function unit with the preference information stored in the storage media 10, and reports the ‘representative location’ that is set for the user preference information.

Additionally, the location information system of the present invention can comprise a remote server 12 that activates particular preference information that was set by the user. In the present invention, the entity that handles the function of activating particular preference information according to a user's location is called a ‘remote server’, and the location of the remote server 12 may differ depending upon the wireless network architecture.

The remote server 12 may be a physical entity that exists independently, or may be included within one entity that is already part of a conventional wireless network architecture. Thus, for activating the operations of a particular terminal 13 in a few regions designated by the user, interfaces between the location server 11 and the remote server 12, between the storage media 10 and the remote server 12, and between the remote server 12 and the terminal 13 must be separately defined. Also, the storage media 10 and the remote server 12 are indicated as being separate entities, but in another embodiment, the storage media 10 may be included within the remote server 12.

In the present invention, the operation of a particular terminal is set according to the user's location, and a field that can transfer the set preference information per user location is added within the protocol interface between the terminal 13 and the storage media 10. Namely, a field for transferring preference information is added to the data transmission format between the terminal 13 and the storage media 10.

The storage media 10 can store particular user preference information, and the location server 11 can determine whether the user enters a preference zone previously set by the user and reports this to the remote server 12. Accordingly, the remote server 12 activates the preference information (particular operation) of the terminal 13 designated by the user if the user enters a user preference zone.

The operations of each interface shown in FIG. 1 are as follows:

Request (remote server 12→storage media 10): Used upon request of preference information related to a particular terminal operation within a particular region. Here, the response is a response to the corresponding request.

Request (user terminal 13→storage media 10): Used when the user wishes to store preference information related to a particular terminal operation of a particular location. Here, the response is a response to the corresponding request.

Request (user terminal 13Δlocation server 11) (subscriber profile function unit): Used when the user wishes to set a particular location as a user preference location. Here, the response is a response to the corresponding request.

Request (remote server 12→user terminal 13): Used when the remote server 12 activates a particular terminal operation (preference information) designated by the user when the user moves to a particular location. Here, the response is a response to the corresponding request.

Final request (location server 11 (subscriber profile function unit)→remote server 12): Used when the subscriber profile function unit determines that the user moved to a particular location and notifies this to the remote server 12. Here, the response is a response to the corresponding request.

FIG. 2 depicts an exemplary flow chart of a user preference information service method in a location information system according to an embodiment of the present invention.

Referring to FIG. 2, the user can manipulate a menu (e.g., a graphic user interface: GUI) that is provided by the terminal to turn on the preference information service. In this state, the user can set the user preference information for his preference regions and the corresponding preference zones (S10). Preferably, the preference information indicates the operations of the terminal or indicates a representative location that represents the user's actual location.

Here, one or more regions (locations) may be set (i.e., registered or designated) as a single user preference zone. Thus, because the user can set various regions as a preference zone, different types of preference information can be set according to particular locations (or zones).

The preference information for a particular region designated by the user can be stored in the storage media 10 through the interface (S11), the preference zone (e.g., the Cell ID, etc. for the corresponding location) and whether the preference information service is set or not (ON or OFF state) are sent to the location server 11 and can be stored in the subscriber profile function unit. Here, the storing operation can be performed by a response of the user profile storage media 10 upon request of the terminal 13, and by a response of the terminal 13 upon request of the location server 11.

Thereafter, the subscriber profile function unit checks whether the preference information service is set or not, or if there is a location tracking request of the user, a request for the user's location is made to a location calculation function unit, which is a location information (physical location) calculating entity within the location server 11 (S12), and checks whether the user's current location is within a particular preference zone (S13). As a result of the check, if the user's current location is within a particular registered preference zone, the subscriber profile function unit reports this fact to the remote server 12, but if the user's current location is not within a particular preference zone, then the process returns to step S12.

Accordingly, the remote server 12 activates the preference information (e.g., particular terminal operations, functions, location reporting method, etc.) that was set by the user for a particular preference zone (S14). Here, because the user preference information is stored in the storage media 10, the remote server 12 requests the storage media 10 to send the preference information, to allow the corresponding preference information to be activated in the user's terminal. In particular, if the preference information indicates a representative location that represents the user's actual location, the subscriber profile function unit compares the user's actual location received from the location calculation function unit with the preference information stored in the storage media 10, and reports the representative location set in the user preference information.

In this manner, when the terminal moves into (enters) a particular region, the location calculating function unit performs the procedures for location measurement with the terminal 13, and provides the user's current location to the subscriber profile function unit, whereby a signaling procedure between the location server and the terminal is required. Thus, the present invention provides a signaling procedure of a location information system based upon a Secure User lane Location (SUPL) technique. Here, it should be understood that many other types of signaling procedures, besides SUPL, could also be used to implement the present invention. Namely, SUPL is merely an example of how to implement the features of the present invention, which thus should not be limited to the SUPL signaling procedures described hereafter.

SUPL is an effective method for sending location information (i.e., a physical location of the user) needed for calculating the location of a mobile terminal, wherein location support information (such as GPS assistance) is sent, and a user plane data bearer is used to carry the protocols related to positioning technology between the mobile terminal and the network.

In a SUPL-based location information system, the SUPL network related to the location service generally comprises a SUPL Agent, a SUPL Location Platform (SLP), and a SUPL Enabled Terminal (SET). The SUPL agent refers to a logical service access point that uses the actually measured location information (physical location), and the SLP refers to a SUPL service access point of a network portion that accesses network resources to obtain location information (physical location) (i.e., the SLP can be considered as a type of application server located at an upper layer than the network itself. The SET is an element that can communicate with the SUPL network using a SUPL interface, and may include a UMTS User Terminal (User Equipment: UE), a GMS Mobile Station (MS), a IS-95 MS, a laptop computer, a PDA or the like having SET functions therein. Alternatively, various types of mobile terminals that can access a WLAN may be used. The SET supports the SUPL-defined procedures by interworking with the network via the user plane bearer. Accordingly, the terminal 13 and the wireless network may be implemented in the form of a SUPL network, whereby the SLP corresponds to the location server, and the SET corresponds to the terminal.

In the present invention, the SET location is provided to the user when there is a location tracking request (i.e., a Standard Location Immediate Service) or when a particular time period or a particular event takes place (i.e., a Triggered Location Reporting Service). The particular event can include various events, such as when a user that uses the SET enters or leaves a particular region, or when the user is initially in a state where an event or location estimation is not possible (e.g., when communication is not possible in an underground location such as on the subway), but later when location estimation becomes possible, the corresponding event is then informed.

Also, the present invention informs by clear indication as to when the SUPL positioning (SUPL location measurement) procedures begin. To do so, the terminal uses a SUPL report to inform the SUPL network that the SUPL positioning procedures have begun. Here, instead of the SUPL report, a SUPL start message can also be used by the SLP to inform the start of the SUPL positioning procedures. Hereafter, the positioning will also be referred to as location measurement.

First, the procedures for location measurement in the SUPL network will be explained. In general, the SUPL location service can be divided into a network-initiated service and a SET-initiated service.

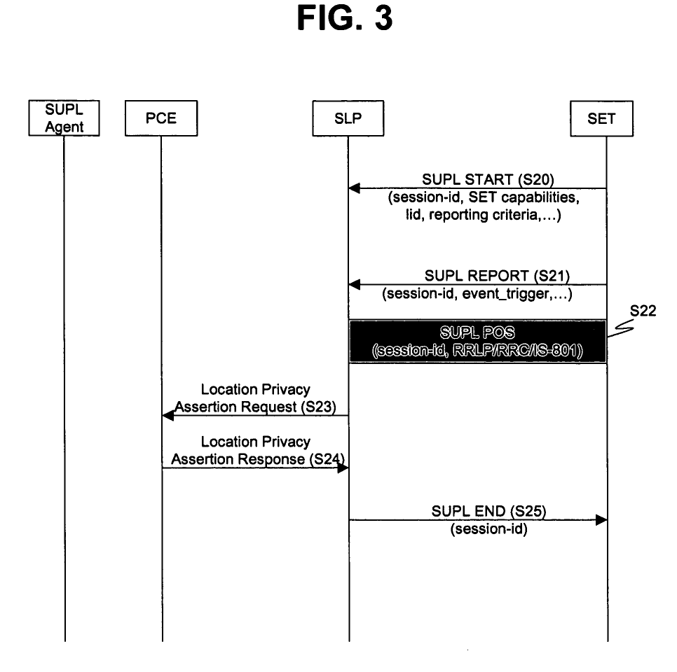

FIG. 3 depicts a message flow diagram of a SET-initiated location reporting service according to an embodiment of the present invention. Here, the SLP refers to the wireless network side and the SET refers to the terminal side, while a SUPL agent may exist in both the network and the terminal or may exist as a separate entity.

Referring to FIG. 3, the SUPL agent of the SET starts the SLP and positioning session, and to begin the location measurement procedures, a SUPL START message is transmitted to the SLP (S20). The SUPL START message includes various parameters, such as a Session ID, SET capabilities, a local identifier (lid), reporting criteria, etc. The SET capabilities include location measurement methods that are supported (e.g., MS assist A-GPS and MS based A-GPS, cell-id method) and their associated location measurement protocols (e.g., RRLP, RRC, IS-801). Also, the SET can additionally provide a NMR for the wireless technique (e.g., GSM: TA, RXLEV) being employed.

The reporting criteria is the criteria used for reporting a particular event or a user location, and for periodic location measurements, the start point, period, and end point of the location tracking can be included. Also, the criteria can be set such that the situations when a user enters a certain region, exits a certain region, or exists within a certain region are informed. In this case, the name of a particular location, the latitude and longitude information of the particular region, etc. can be included as the reporting criteria. Also, an event related to a particular region and a periodic event may be combined together.

For example, the reporting criteria may include a representative location (e.g., a proxy location, a pseudo location, an abstract location, a symbolic location, a conceptual location, a theoretical location, etc.) that reflects user preference information. The representative location is a type of user preference information that reflects (considers) the user's actual location, and represents a location designated (set) according to preference zone ranges that are designated (set) by the user. Thus, when the user is located within a region (preference zone) being set as ‘home’, and upon request for location tracking of the user, the SET does not report the user's actual location value (for example, the x, y, z coordinates) but reports a value representing the ‘home’ set by the user (for example, a zip code, neighborhood name, region name, etc.).

When a SUPL START message arrives from the SET, the SLP checks the protocol that includes the SUPL START message and determines which location measurement protocol should be used. Then, when location tracking is requested, the SET transmits a SUPL REPORT message that instructs the start of SUPL location measurement procedures to the SLP (S21). Here, the SUPL REPORT message includes a session ID, an event trigger, and the like. Also, the SUPL START message and the SUPL REPORT message may be combined together. Namely, when a particular event occurs, a SUPL START message may be sent to inform that the particular event has occurred and the SUPL related procedures may be started. If the SUPL START and SUPL REPORT messages are separated, the SUPL related procedures are initially begun with the SUPL START message, and then upon occurrence of a particular event, a SUPL REPORT message is sent.

Accordingly, the SLP performs the SUPL location measurement procedures in which SUPL location measurement messages (e.g., SUPL POS messages) are sent back and forth according to the SUPL REPORT message (S22). In this case, based upon the location measurements received from the SET, the SLP calculates the estimated location (MS assisted method) or the SET calculates the estimated location based upon the assistance obtained from the SLP (MS based method). If the SLP calculates the estimated location based upon the location measurements received from the SET (MS assisted method), this needs to be informed to the SET, and a separate SUPL REPORT message can be used to send the calculated value in the corresponding message. Also, at the end of the SUPL POS procedure, if the SLP calculates the location racking based upon the location measurement received from the SET, the SUPL POS message may be transmitted from the SLP to the SET once again.

When the location calculation is complete, the SLP sends a location privacy assertion request message to the PCE and requests the preference information of the SET that is the subject of location tracking (S23), and the PCE transmits the location privacy assertion response message (that includes preference information of the SET) to the SLP (S24).

Accordingly, the SLP checks whether the calculated user location is within a particular preference zone, and if the user is currently within a registered particular preference zone, the calculated user location is reported to the SET. In the present invention, the user's actual location is not reported, but preference information that represents the corresponding preference zone (namely, a representative location) is reported to the SET. This representative location is included in a SUPL END message that indicates that the location session has been completed indicating an end of the location measurement procedure (S25).

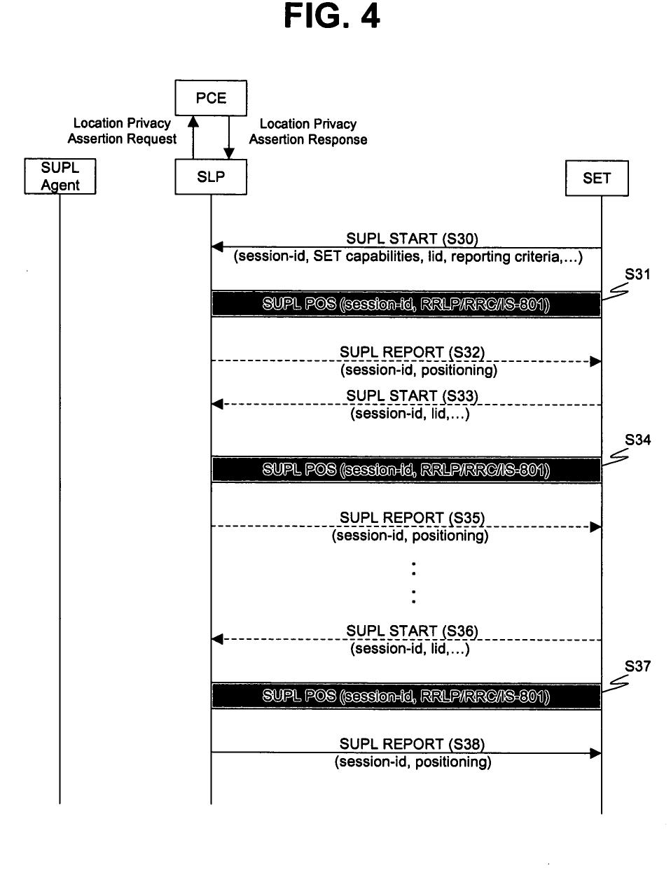

FIG. 4 depicts a message flow diagram of a SET-initiated location reporting service according to another embodiment of the present invention, showing an example of continuous exchanging of SUPL POS messages between the SLP and SET.

As shown in FIG. 4, the SUPL agent in the SET starts a positioning session with the SLP and in order to start the location measurement procedures, a SUPL START message is transmitted to the SLP (S30) and the SLP performs the SUPL location measurement procedures by sending and receiving SUPL POS messages with the SET (S31).

As an example, in the SET initiated operation mode, namely, for the mode in which the SET calculates the location estimation based upon the assistance from the SLP, the SET and the SLP exchange SUPL POS messages for providing necessary support data and the terminal location is calculated by the SET.

Also, in the SET assisted operation mode, namely, for the mode in which the SLP calculates the location estimation based upon the location measurement value received from the SET, the SET and SLP exchange SUPL POS messages and the terminal location is calculated by the SLP. In particular, in SET assisted mode, the SLP can perform optional (or additional) procedures for reporting the calculated location estimation value to the SET through the SUPL REPORT (S32), and for this, the SET performs, before the SUPL POS, optional procedures for transmitting a SUPL start message to the SLP, if necessary. The above step (S32) can be performed once per interval if needed, namely, can be repeated in the steps S35 and S38, while step S33 may be repeated in step S36.

Referring to FIG. 4, it should be noted that privacy assertion procedures may be performed before SUPL reporting. Namely, the SLP cooperates with the PCE, whereby the SLP sends a location privacy assertion request to the PCE, which then sends a location privacy assertion response to the SLP. By doing so, user privacy and authentication may be better guaranteed.

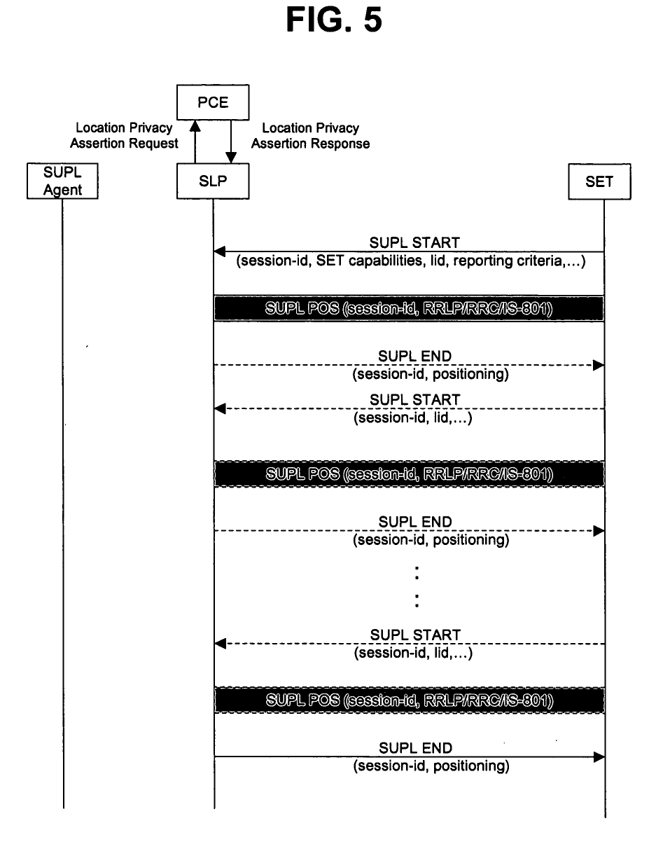

FIG. 5 depicts a message flow diagram of a SET initiated location reporting service according to another embodiment of the present invention. The features in FIG. 5 is basically the same those in FIG. 4, but instead of separately using a SUPL REPORT message, the location estimation value within the SUPL END message is reported to the SET, and additional (optional) procedures may be performed. In FIG. 5, the calculated location estimation value is not reported to the SET in the SUPL END message, but the calculated location estimation value is included at the end of the SUPL POS procedure, and the SUPL END can be used merely for the purpose of ending the SUPL procedures.

The network initiated location report service of the present invention can be divided into a triggered location reporting service and a standard location immediate service. The triggered location reporting service is a service that provides the location information (physical location) of the SET a certain time intervals or when a particular event occurs, while the standard location reporting service is a service used when a reply to a location request is immediately requested.

Referring to FIG. 5, it should be noted that privacy assertion procedures may be performed before SUPL reporting. Namely, the SLP cooperates with the PCE, whereby the SLP sends a location privacy assertion request to the PCE, which then sends a location privacy assertion response to the SLP. By doing so, user privacy and authentication may be better guaranteed.

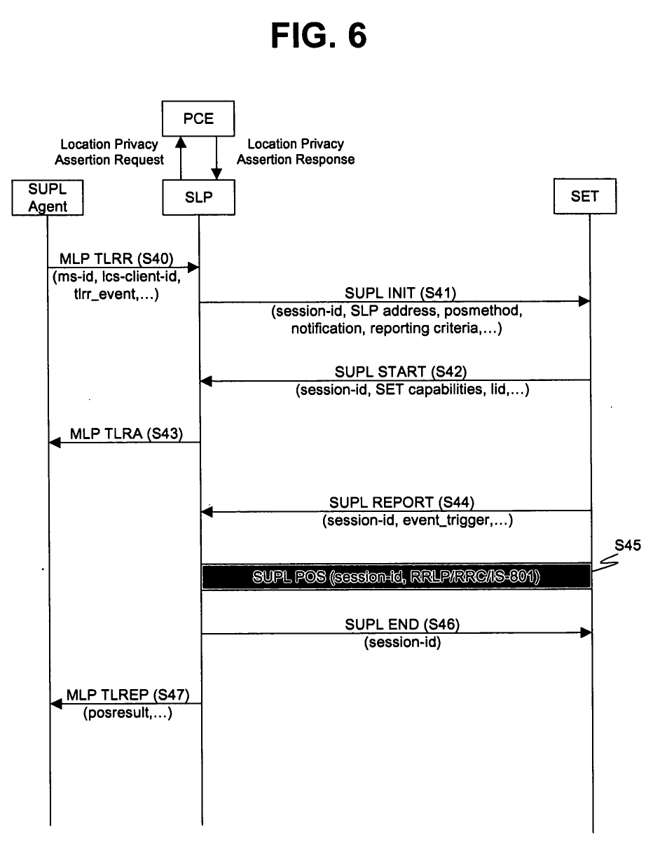

FIG. 6 depicts a message flow diagram of an example of a network initiated triggered location reporting service according to the present invention.

Referring to FIG. 6, the SUPL agent establishes a location report criteria (event) through a MLP (Mobile Location Protocol) TLRR (Triggered Location Reporting Request). Here, the MLP TLRR message can include an ms-id, a LSC (Location Service Client)-client-id, an event (TLRR_event) to be triggered (a criteria that has been set), etc. The location report criteria can include a particular SET operation (UE unavailable), a certain time interval, a change of area, etc., and when one of the above criteria occurs, the location report will be performed.

The SLP authorizes the SUPL agent based upon the received client-id, and performs a user privacy check for the client-id based upon the ms-id. When the SUPL agent authorization is complete, the SLP transmits a SUPL INIT message (that can be a WAP PUSH or SMS trigger) to the SET (S41), to begin a location session with the SET. The SUPL INIT message can include at least a session ID, an address of the SLP, a location measurement method (pos_method), the triggered reporting criteria, etc.

As a result of the privacy check, if notification to or confirmation from the SET is needed, the SLP includes a notification element within the SUPL INIT message. Upon receiving the SUPL INIT message, the SET guesses (presumes) the appropriate notification rules (procedures), the SUPL START message is sent to the SLP, and the SUPL POS session is started with the SLP (S42).

The SUPL START message can include at least a session ID, SET capabilities, a location id (lid), etc. As in the case of the SET initiated location request of FIG. 3, the location measurement protocol related to the assisted location measurement method (e.g., MS assist A-GPS and MS based A-GPS, cell-id method) is included in the SET capabilities. Also, the NMR for the wireless technique (e.g., GSM: TA, RXLEV) use by the SET can be optionally or additionally provided.

When the SUPL START message arrives from the SET, the SLP checks the SUPL START message and determines what location measurement protocol (RRLP, RRC, IS-801) should be used. When the protocol to be used is determined, the SLP transmits to the SUPL agent a MLP TLRA (Triggered Location Reporting Answer), which indicates that a location measurement session is in progress for the requested triggered location report (S43).

Thereafter, if a requested event occurs, the SET transmits to the SLP, a SUPL REPORT message indicating the start of the SUPL location measurement procedures (S44), and the SLP begins the SUPL location measurement procedures according to the SUPL REPORT message (S45). In this case, the SLP and SET can continuously exchange SUPL POS messages multiple times.

In the above SUPL location measurement step (S45), the SLP calculates the location estimation value based upon the location measurement values received from the SET (MS assisted method), but the location measurement can be performed by the SET based upon the assistance obtained from the SLP (MS based method). Here, a SUPL START message may be used instead of the SUPL REPORT message. If the SET calculates the location estimation value based upon the assistance obtained from the SLP (MS based method), the SET needs to inform the calculated value to the SLP, and this may be performed at the end of the SUPL location measurement procedure or a separate SUPL REPORT message can be used. This will be explained further in the following another embodiment.

When the location calculation is complete, the SLP transmits a SUPL END message to inform the SET that the location measurement procedures have been completed and the location session is done (S46), then requests the PCE for the preference information of the SET, and checks whether the calculated location of the user is within a particular preference zone. If the calculated user location is within a registered particular preference zone, the SLP transmits to the SUPL agent, not the user's actual location, but a preference information (namely, a representative location) that represents the corresponding reference zone, by using a MLP TLREP (Triggered Location Report) (S47).

Referring to FIG. 6, it should be noted that privacy assertion procedures may be performed before SUPL reporting. Namely, the SLP cooperates with the PCE, whereby the SLP sends a location privacy assertion request to the PCE, which then sends a location privacy assertion response to the SLP. By doing so, user privacy and authentication may be better guaranteed.

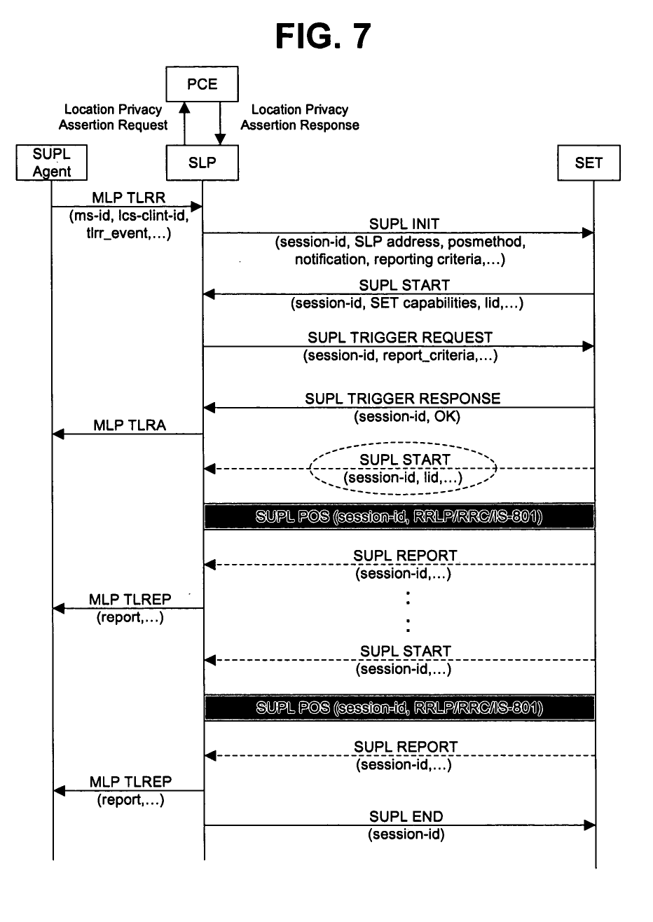

FIG. 7 depicts a message flow diagram of a network-initiated triggered location reporting service according to another embodiment, whereby the SLP and SET continuously exchange location measurement procedure messages multiple times. In this embodiment, unlike in FIG. 6, the SET informs the SLP of the fact that a particular event occurred and a SUPL START message is used to start a location measurement procedure. In particular, in FIG. 7, if the SET calculates a location estimation value based upon the assistance obtained from the SLP (MS based method), the SET needs to inform a the SLP of the calculated value, and the additional (optional) step of reporting the calculated location estimation value to the SET by using a SUPL REPORT message, is different from FIG. 6.

Referring to FIG. 7, it should be noted that privacy assertion procedures may be performed before SUPL reporting. Namely, the SLP cooperates with the PCE, whereby the SLP sends a location privacy assertion request to the PCE, which then sends a location privacy assertion response to the SLP. By doing so, user privacy and authentication may be better guaranteed.

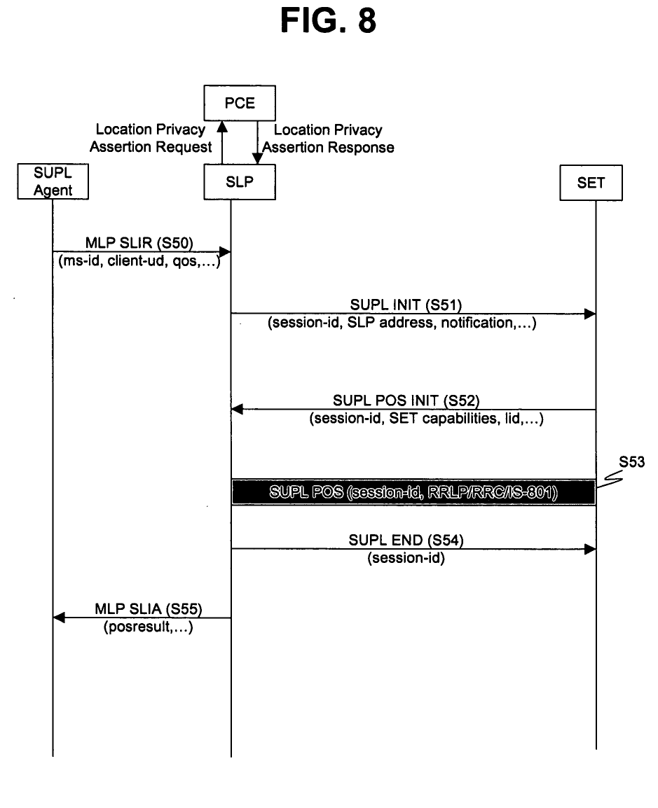

FIG. 8 depicts an example of a message flow diagram of a network initiated standard location reporting service.

As shown in FIG. 8, the SUPL agent requests location information (physical location) through a MLP SLIR (Standard Location Immediate Request) (S50). The MLP SLIR message can include an ms-id, a client-id, a QoS, etc. The SLP transmits a SUPL INIT message to the SET after performing authorization of the SUPL agent and the subscriber privacy check (S51) in order to start a location session with the SET. The SUPL INIT message includes at least a session-id and a SLP address, and as a result of the privacy check, if notification or confirmation from the SET is required, a notification is also included therein.

Upon receiving the SUPL INIT message from the SLP, the SET establishes a data connection with the SLP according to the address obtained from the SUPL INIT message, and then performs the SUPL POS session through the SUPL POS INIT (S52). Through the SUPL POS session, the SLP determines the location measurement protocol (RRLP, RRC, IS-801) to be used from the SET, and then begins the SUPL location measurement procedures with the SET (S53).

Thereafter, when the location calculation is complete, the SLP transmits a SUPL END message and informs the SET that the location session has ended upon completion of the location measurement procedures (S54). Also, the SLP requests to the PCE the preference information of the SET, then checks whether the calculated user location is within a particular preference zone, and if the calculated user location is within a registered particular preference zone, the SLP transmits to the SUPL agent via a MLP SLIR (Standard Location Immediate Answer), not the user's actual location but the preference information (namely, a representative location) that represents a corresponding preference zone (S55).

Referring to FIG. 8, it should be noted that privacy assertion procedures may be performed before SUPL reporting. Namely, the SLP cooperates with the PCE, whereby the SLP sends a location privacy assertion request to the PCE, which then sends a location privacy assertion response to the SLP. By doing so, user privacy and authentication may be better guaranteed.

In the present invention, the user preference information need not be stored in a network element (e.g., the PCE), but stored in the terminal itself to allow activation of preference information functions according to the user's location. The present invention performs the preference information according to the following two types of situations.

In a first method, where the corresponding terminal application is the entity that performs the method, the user establishes user preference information in the terminal application, the corresponding application receives the current location of the terminal from a location enabler within the terminal and performs the established preference information (representative location report) corresponding to the current location.

In a second method, where a location enabler of the terminal is the entity the performs the method, the location enabler sends the location information (physical location) of the terminal to the corresponding terminal application, and the corresponding application performs the user preference information according to the terminal location.

In both of the above two methods, the location information (physical location) can be reported at certain time intervals (periodically) or when a particular event is triggered, or can be reported immediately according to a request for actual location information (physical location).

The above two methods are divided merely depending upon what the performing entity is, but the features of performing the user preference information in a different manner according to the location is the same. Thus, when the above embodiments are applied, the corresponding functions can be performed by the cooperation of the location enabler and the application within the terminal, without having to store the user preference information in a network element, such as a storage media.

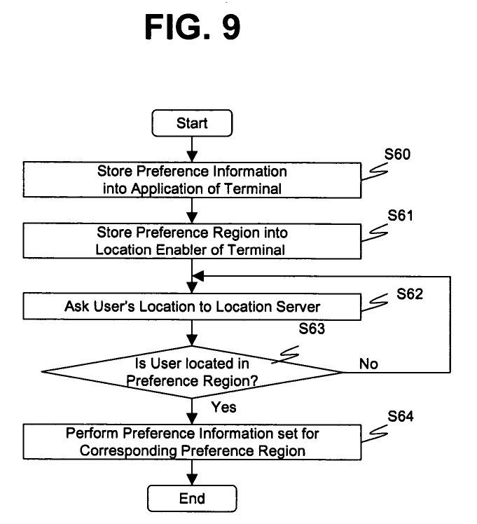

FIG. 9 depicts a flow chart of the user preference information service of a location information system according to an embodiment of the present invention.

The user manipulates a menu on the terminal to select the preference information service, and then sets his desired preference information (e.g., particular terminal operations and location report methods) for each preference zone (S60). In this manner, the user can establish multiple regions (physical locations) as preference zones.

Accordingly, when the preference information is stored in the terminal application, the information of the preference zone (e.g., a Cell id of the corresponding region) designated by the user is also stored in the location enabler within the terminal (S61).

Thus, when the preference information service function is turned on, the location enabler asks for the user location from the location server periodically or when a designate event occurs, or requests the location server to inform that a corresponding event occurs when the user enters (or leaves) a pre-designated preference zone (S62).

Thereafter, when the user is located within one of the pre-designated preference zones, the preference information designated for that preference zone is performed at the location enabler or the terminal application (S63, S64). Namely, if the terminal application is the performing entity, the terminal application requests the current location of the terminal from the location enabler to thus output the preference information (e.g., representative location) according to the terminal's current location. In contrast, if the location enabler is the performing entity, the location enabler sends the location information (physical location) to the corresponding terminal application, and the corresponding application outputs a representative location corresponding the terminal's current location.

As described above, the present invention has the effect of better satisfying various needs of the user (e.g., being able to use and control certain functions of his terminal according to the user's physical location) by allowing the user to set different user preferences related to the methods of reporting the user's location, related to the operation methods of the terminal, and related to the information displayed on the terminal in accordance with the location of the user.

Also, for location measurement between the terminal and the location server, the present invention (in certain non-limiting embodiments) provides in the SUPL network, a message sending scheme between each SUPL element, whereby, in particular, the SET sends a SUPL REPORT message to the SLP that clearly indicates the start of the SUPL location measurement, to allow the network to effectively perform SUPL location measurements.

The features of the present invention can be briefly stated as being related to reporting of a ‘representative’ location based on user profiles. This pertains to the capability of a location enabler to provide users with a mechanism to return a representative location (e.g., an abstract location) based on the user's profile settings and the user's current physical location. For example, a user may specify a ‘home’ profile that describes the location range (boundary) of his home. When a request is made for his location, a comparison is made between the user's pre-set profile and the actual physical location of the user. If the current actual location matches the pre-set profile for ‘home’, then the user-specified location (a representative location indicating a zip code, city, etc.) is returned.

However, it should be noted that emergency services and lawful purposes can override any user preference setting. For example, even if the user had set his user profile so that outgoing calls cannot be made when the user is traveling outside his home city (or other location specified by the user), emergency calls (for example, calling the police or fire department) will still be permitted upon overriding the user profile settings.

The present invention can also be described in the following manner with respect to five procedures. First, the user selects functionality to view and edit his profile setting. Second, the user sets his profile for report of a representative (pseudo) location, for example, by defining a ‘home’ location range. Third, the mobile location service (MLS) application requests the user's location with specific QoS (quality of service), for example, by using an external MLS application that requests a user's location by specifying the location with a specific accuracy level. Fourth, the user is positioned (i.e., position is located) by using known positioning mechanisms. Fifth, if the user's physical location overlaps with the pre-specified range, then the representative location is returned to the requesting MLS application. Here, for lawful and emergency requests, this fifth step can be bypassed and only the true physical location is returned. Also, it should be noted that if no representative location is provided by the user, then a (pre-defined) default location may be employed.

Preferably, because Mobile Location Services are time-sensitive, all MLS events and transactions shall be time-stamped and shall use the most recent up-to-date data available. Also, the Mobile Location Services can provide a wide variety of data presentation formats, such as advanced geographical services that include, but not restricted to navigation and routing services, provisioning of maps, search and information about points of interest (POIs), geocoding and reverse geocoding services (such as translating x-y coordinates to street names, POIs, etc.), and searching services. Additionally, data integrity and security should be maintained such that delivery of data content is trustworthy and reliable, and be protected against eavesdropping or unauthorized modification. Furthermore, the Mobile Location Services should provide access-independent, uninterrupted service while roaming across IP-based wireless networks, contingent upon the reliability of underlying transports and mutual agreements and supporting infrastructure from participating service providers.

In the above description, the teachings and suggestions related to the use of ‘representative’ locations (e.g., a proxy location, a pseudo location, an abstract location, a symbolic location, etc.), setting different user preferences for different locations to provide the user with different terminal operations according to his physical location, and the required interface techniques therefor are preferably directed one or more service coverage areas managed by a single service provider. However, the present teachings and suggestions can also be applied to multiple service coverage areas that are respectively managed by different service providers.

Furthermore, those skilled in the art would clearly understand that the specific teachings of the present invention and reasonable suggestions derived therefrom are related to the various technical issues or enhancements being discussed and agreed upon by the Open Mobile Alliance (OMA), which addresses market driven needs by specializing in the development of various mobile service applications that allow interoperability with other mobile (or wireless) networks, and the development of enablers that are independent entities with respect to a mobile (or wireless) network.

As such, some of the terminology used herein has yet to be specifically agreed upon and certain concepts are referred to as different names by various companies and organizations. For example, regarding the techniques for reporting the user's location (employing a ‘representative’ location instead of the user's actual location), the triggered case (as referred to by the OMA) is called a ‘default case’ by the 3GPP, while the immediate case (as referred to by the OMA) is called a ‘standard case’ by the 3GPP. However, those skilled in the art would clearly understand the concepts and features provided herein, despite their different terms and expressions, which may even be changed in the future.

The foregoing description of the preferred embodiments is provided to enable any person skilled in the art to make or use the present invention. Various modifications to these embodiments will be readily apparent to those skilled in the art, and the generic principles defined herein may be applied to other embodiments. Thus, the present invention is not intended to be limited to the embodiments shown herein but us to be accorded the widest scope consistent with the principles and novel features disclosed herein.

1. A user preference service method, comprising:
setting by a user, a user profile for reporting a representative location;
obtaining location information indicating a physical location of the user; and
reporting the representative location if the obtained location information overlaps with the representative location; and
activating at least one user preference set by the user or at least one user terminal operation set by the user, based upon the physical location of the user.

2. The method as claimed in claim 1, further comprising:
storing user preferences within a location server having a subscriber profile function unit therein; and
activating the at least one user preference or the at least one user terminal operation if a user terminal enters into and is located within a particular physical region.

3. The method as claimed in claim 1, further comprising:
comparing a value of the user's actual physical location that is provided from a location calculation function unit with user preferences stored in a storage medium, if there is a tracking request of a user; and
activating the at least one user preference or the at least one user terminal operation according to the comparing.

4. The method as claimed in claim 3, wherein the tracking request comprises:
receiving a request for location information of the user upon occurrence of a designated event or is received periodically.

5. The method as claimed in claim 4, wherein the designated event is when the user enters or leaves a pre-defined physical location or area.

6. The method as claimed in claim 4, wherein the designated event is when the user is initially in a state where location estimation is not possible, but later location estimation becomes possible.

7. The method as claimed in claim 1, wherein the user profile includes user preference information containing the representative location to be reported.

8. The method of claim 7, wherein the representative location represents one or more user preference zones, each user preference zone being a physical region designated by the user.

9. The method as claimed in claim 1, wherein the steps are performed by employing a user plane data bearer service.

10. The method as claimed in claim 9, wherein the steps are performed for a Secure User Plane Location (SUPL) network, comprising a SUPL Agent, a SUPL Location Platform (SLP), and a SUPL Enabled Terminal (SET).

11. A user preference service method, comprising:
activating at least one user preference set by the user or at least one user terminal operation set by the user, based upon a physical location of the user,
by receiving user preferences to be stored in a subscriber profile function unit, and activating the at least one user preference or the at least one user terminal operation if a user terminal enters into and is located within a particular physical region, or
by comparing a value of the user's actual physical location that is provided from a location calculation function unit with user preferences stored in a storage medium, if there is a tracking request of a user, and activating the at least one user preference or the at least one user terminal operation according to the comparing.

12. The method as claimed in claim 11, wherein if there is a tracking request, performing prior to the activating, the steps of:
receiving a request for location information indicating a physical location of the user terminal;
obtaining the location information of the user terminal;
comparing the obtained location information with stored user preference information containing at least one representative location to be reported; and
reporting a particular representative location if the obtained location information overlaps with a range of the particular representative location based upon the comparing.

13. The method as claimed in claim 12, wherein the obtaining step involves accessing a network entity in which the user preference information is stored.

14. The method as claimed in claim 12, wherein the obtaining step involves negotiation with the user terminal for calculating the location information of the user terminal.

15. The method as claimed in claim 12, wherein the representative location represents one or more user preference zones, each user preference zone being a physical region designated by the user.

16. The method as claimed in claim 11, wherein the tracking request comprises:
receiving a request for location information of the user upon occurrence of a designated event or is received periodically

17. The method as claimed in claim 16, wherein the designated event is when the user enters or leaves a pre-defined physical location or area.

18. The method as claimed in claim 16, wherein the designated event is when the user is initially in a state where location estimation is not possible, but later location estimation becomes possible.

19. A user preference service method, comprising:
allowing a user to set a user profile including user preference information containing a representative location to be reported;
calculating a location information indicating a physical location of the user wherein the location information is calculated by the location server if an agent server requests a user's location information;
comparing the physical location with the user preference information; and
reporting the user representative location information to the agent server.

20. The method of claim 19, wherein the reporting is performed if the location information overlaps with a range of the representative location.

21. The method of claim 19, wherein the reporting includes activating the user preference information.

22. The method of claim 19, wherein the user profile is stored in a network entity.

23. The method of claim 22, wherein the calculating step involves retrieving the user profile information stored in the network entity.

24. A user preference service method, comprising:
storing preference information in an application of a user terminal;
storing a preference region in a location enabler of the user terminal;
requesting a user location from a location server; and
if the user location overlaps with the preference region, activating the preference information associated with the preference region.

25. The method of claim 24, wherein the preference information contains a representative location to be reported.

26. The method of claim 25, wherein the representative location represents one or more user preference zones, each user preference zone being a physical region designated by the user.

27. The method of claim 24, wherein the requesting is performed upon occurrence of a designated event or is performed periodically.

28. The method of claim 27, wherein the designated event is when the user enters or leaves a pre-defined physical location or area.

29. The method of claim 27, wherein the designated event is when the user is initially in a state where location estimation is not possible, but later location estimation becomes possible.

30. The method of claim 24, wherein the steps are used to allow a user to access different user terminal functions that are activated according to the user's physical location.

31. The method of claim 24, wherein the steps are performed by employing a user plane data bearer service.

32. In a Secure User Plane Location (SUPL) based location information system, a user preference service method comprising:
transmitting by a SUPL Enabled Terminal (SET), a SUPL start message to a SUPL Location Platform (SLP);
determining, by the SLP, a location of the SET by sending and receiving SUPL position messages with the SET;
requesting user preference information to a Privacy Check Entity (PCE); and
upon receiving the user preference information, reporting to the SET by using a SUPL end message, a user preference information that had been set for a preference region in which the SET is currently located in.

33. The method of claim 32, wherein the SUPL start message is transmitted periodically or when a particular event is triggered or when the SET requests transmission.

34. The method of claim 32, wherein the user preference information is requested through a location privacy assertion request message.

35. The method of claim 32, wherein the user preference information is received through a location privacy assertion request message.

36. The method of claim 32, wherein the start message comprises parameters indicating a session ID, SET capabilities, a location identifier, and a report basis.

37. The method of claim 36, wherein the SET capabilities comprise location measurement methods that are supported and their related location measurement protocols.

38. The method of claim 36, wherein the location measurement procedure using the SUPL position messages is repeated multiple times.

39. The method of claim 36, wherein if the SUPL start message merely indicates a beginning of SUPL related procedures, the SET additionally transmits to the SLP a SUPL report message indicating an occurrence of a particular event.

40. In a Secure User Plane Location (SUPL) based location information system, a user preference service method comprising:
establishing by a SUPL agent, at least one location report condition in a SUPL Location Platform (SLP);
performing a location session by transmitting a SUPL initialization message from the SLP to a SUPL Enabled Terminal (SET), if the at least one location report condition is satisfied;
starting a location measurement by transmitting a SUPL start message from the SET to the SLP;
measuring a location of the SET by the SLP upon sending and receiving SUPL position messages with the SET;
informing that location measurement procedures have been completed by transmitting a SUPL end message from the SLP to the SET, when the location of the SET has been calculated;
requesting user preference information from a Privacy Check Entity (PCE) by the SLP; and
upon receiving the user preference information, reporting to the SUPL agent, a user preference information that had been set for a preference region in which the SET is currently located in.

41. The method of claim 40, wherein the location report condition is established through a MLP TLRR (Triggered Location Reporting Request) message.

42. The method of claim 41, wherein the MLP TLRR message comprises a SET-id, a location service client-id, and an event to be triggered, and the location report condition comprises at least one of a particular SET operation, a certain time interval, and a change of area.

43. The method of claim 40, wherein SUPL start message is transmitted periodically or when a particular event is triggered.

44. The method of claim 40, wherein the user preference information is requested through a location privacy assertion request message.

45. The method of claim 40, wherein the user preference information is received through a location privacy assertion request message.

46. The method of claim 40, wherein the SUPL initialization message comprises parameters indicating a session ID, a SLP address, a compression method, SET capabilities, and a notification and a report basis.

47. The method of claim 46, wherein if the SUPL start message comprises a session ID, SET capabilities, and a location identifier.

48. The method of claim 40, wherein if the SUPL start message merely indicates a beginning of SUPL related procedures, the SET additionally transmits to the SLP a SUPL report message indicating an occurrence of a particular event.

49. The method of claim 40, wherein the SLP reports the user preference information through a MLP TLRR (Triggered Location Reporting Request) message.

50. In a Secure User Plane Location (SUPL) based location information system, a user preference service method comprising:
requesting by a SUPL agent, a location report of a SUPL Enabled Terminal (SET) from a SUPL Location Platform (SLP);
performing a location session by transmitting a SUPL initialization message from the SLP to the SET;
starting a location measurement by transmitting a SUPL position initialization message from the SET o the SLP;
measuring a location of the SET by the SLP upon sending and receiving SUPL position messages with the SET;
informing that location measurement procedures have been completed by transmitting a SUPL end message from the SLP to the SET, when the location of the SET has been calculated;
requesting user preference information from a Privacy Check Entity (PCE) by the SLP; and
upon receiving the user preference information, reporting to the SUPL agent, a user preference information that had been set for a preference region in which the SET is currently located in.

51. The method of claim 50, wherein the location report condition is established through a MLP TLRR (Triggered Location Reporting Request) message.

52. The method of claim 50, wherein the SUPL initialization message comprises parameters indicating a session ID, a SLP address, and a notification.

53. The method of claim 50, wherein the user preference information is requested through a location privacy assertion request message and is received through a location privacy assertion response message.

54. The method of claim 50, wherein the SUPL position message comprises parameters indicating a session ID, a SLP address, a location identifier, and SET capabilities.

55. The method of claim 50, wherein the SLP reports the user preference information through a MLP SLIA (Standard Location Immediate Answer) message.

56. The method of claim 50, wherein the SLP reports an actual location of the SET for an emergency service.

57. A mobile communications system comprising:
a user terminal adapted to allow a user to set a user profile including user preference information containing a representative location to be reported; and
a location server adapted to receive a request for location information that indicates a physical location of the user, and to report the representative location if the location information overlaps with the representative location.

58. The system as claimed in claim 57, wherein the user preference information is stored in a network entity or in the user terminal.

59. The system as claimed in claim 57, wherein the location server is adapted to obtain the location information of the user, and to compare the obtained location information with the set user preference information, prior to reporting the representative location.

60. The system as claimed in claim 57, wherein the user terminal is adapted to obtain the location information of the user, and to compare the obtained location information with the set user preference information, prior to reporting the representative location by the location server.

61. A location server comprising:
a location calculation function unit adapted to receive a request for location information that indicates a physical location of the user terminal, and to obtain the location information of the user terminal; and
a subscriber profile function unit adapted to store user preference information, to compare the obtained location information with the stored user preference information containing at least one representative location to be reported, and to report a particular representative location if the obtained location information overlaps with the particular representative location based upon the comparing performed by the location calculation function.

62. A user terminal comprising:
a terminal application adapted to allow a user to set a user profile including user preference information containing a representative location to be reported; and
a location enabler adapted to optionally calculate a location information that indicates a physical location of the user terminal and optionally negotiate with a location server to perform the calculating, and to compare the location information with the user preference information.

63. The user terminal as claimed in claim 62, wherein the terminal application or the location enabler activates the user preference information related to a representative location that is reported, if the location information overlaps with the representative location.
